(19) United States
(12) Patent Application Publication
(10) Pub. No.: US 2024/0160383 A1
(43) Pub. Date: May 16, 2024

(54) METHOD FOR MANAGING STORAGE CONTROLLERS, ELECTRONIC DEVICE, AND COMPUTER READABLE STORAGE MEDIUM THEREOF

(71) Applicant: Fulian Precision Electronics (Tianjin) Co., LTD., Tianjin (CN)

(72) Inventor: JIE YUAN, Tianjin (CN)

(21) Appl. No.: 18/211,640

(22) Filed: Jun. 20, 2023

(30) Foreign Application Priority Data
Nov. 12, 2022 (CN) 202211416384.6

(51) Int. Cl. G06F 3/06

(52) U.S. Cl. CPC G06F 3/0658; G06F 3/0665; G06F 3/0604; G06F 3/0683

(57) ABSTRACT

A method for managing storage controllers of an electronic device comprises acquires driver configuration files of first and second storage controller. A driver mapping file of a root file system is acquired according to the driver configuration files of the first storage controller and the second storage controller. The driver configuration file of the second storage controller is updated. A driver image file of the virtual file system is updated according to the driver configuration file of the second storage controller. An operation system of the electronic device is rebooted. The driver of the second storage controller is started according to the driver image file when the virtual file system starts, and the driver of the first storage controller is started according to the driver mapping file when a root file system starts. An electronic device and a computer readable storage medium applying the method are also disclosed.

### FIELD

The subject matter herein generally relates to computer technology.

### BACKGROUND

In an electronic device, a storage controller is provided to manage the storage mediums. While starting an operation system of the electronic device, drivers of the storage controller is firstly started for scanning storage mediums. The storage controller allocates drive letters to the storage mediums according to a scanning order. The drivers of the storage controller are run multithreaded, which is difficult to determining a sequence of running the drivers. The drive letters are randomly allocated, thus the drive letters may be shifted.

There is room for improvement in the art.

### BRIEF DESCRIPTION OF THE DRAWINGS

Implementations of the present disclosure will now be described, by way of example only, with reference to the attached figures.

FIG. 1 is a diagram illustrating an embodiment of an electronic device in a related art.

FIG. 2 is a diagram illustrating a first embodiment of an electronic device according to the present disclosure.

FIG. 3 is a diagram illustrating a second embodiment of an electronic device according to the present disclosure.

FIG. 4 is a flowchart illustrating an embodiment of a method for managing the storage controllers according to the present disclosure.

FIG. 5 is a diagram illustrating an embodiment of the drive letters allocated by the electronic device of FIG. 2 according to the present disclosure.

### DETAILED DESCRIPTION

The present disclosure is described with reference to accompanying drawings and the embodiments. It will be understood that the specific embodiments described herein are merely part of all embodiments, not all the embodiments. Based on the embodiments of the present disclosure, it is understandable to a person skilled in the art, any other embodiments obtained by persons skilled in the art without creative effort shall all fall into the scope of the present disclosure. It will be understood that the specific embodiments described herein are merely some embodiments and not all.

It will be understood that, even though the flowchart shows a specific order, an order different from the specific order shown in the flowchart can be implemented. The method of the present disclosure can include one or more steps or actions for achieving the method. The steps or the actions in the method can be interchanged with one another without departing from the scope of the claims herein.

In general, the word “module,” as used herein, refers to logic embodied in hardware or firmware, or to a collection of software instructions, written in a programming language, for example, Java, C, or assembly. One or more software instructions in the modules may be embedded in firmware, such as an EPROM, magnetic, or optical drives. It will be appreciated that modules may comprise connected logic units, such as gates and flip-flops, and may comprise programmable units, such as programmable gate arrays or processors, such as a CPU. The modules described herein may be implemented as either software and/or hardware modules and may be stored in any type of computer-readable medium or other computer storage systems. The term “comprising” means “including, but not necessarily limited to”; it specifically indicates open-ended inclusion or membership in a so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one.”

Terms “first”, “second”, and the like used in the specification, the claims, and the accompanying drawings of the present disclosure are used to distinguish different objects rather than describe a particular order. A term “comprise” and its variations are intended to cover a non-exclusive inclusion. For example, a process, method, system, product, or apparatus including a series of steps or units is not limited to the listed steps or units, and may optionally include other steps or units that are not listed, or other steps or units inherent to the process, method, product, or device.

It should be understood that, in this embodiment of the present disclosure, “at least one” means one or more, and “a plurality of” means two or more. The term “and/or” is used to describe an association relationship for describing associated objects, and indicates that three relationships may exist. For example, “A and/or B” may represent the following three cases: Only A exists, only B exists, and both A and B exist, where A and B may be singular or plural. In the specification, claims, and accompanying drawings of the present disclosure, the terms “first”, “second”, “third”, “fourth”, and so on are intended to distinguish between similar objects but are not intended to indicate specific order or a sequence.

It will be understood that, even though the flowchart shows a specific order, an order different from the specific order shown in the flowchart can be implemented. The method of the present disclosure can include one or more steps or actions for achieving the method. The steps or the actions in the method can be interchanged with one another without departing from the scope of the claims herein.

Examples of some selected terms are provided as follows.

1. Storage Controller

The storage controller is a device for controlling an accessing of storage medium according to a specified timing rule, which includes the control of address signals, data signals, and other instruction signals, which enables the electronic device accessing a storage medium to use storage resources in the storage medium. A function of the storage controller provides an interface conversion, which converts commands sent by the electronic device, such as read or write, into signals being identified by the storage medium, and decodes an address and converts data format between the electronic device and the storage medium.

The storage controller may include host bus adapter (HBA), redundant array of independent disks (RAID), and the like, but not being limited.

2. Driver

The driver is short for driver programs. The driver is a driver program in the storage controller and is specified program added into an operation system of the electronic device, which includes related information of electronic device. The related information may enable the electronic device to communicate with the corresponding storage controller, therefore the electronic device can access a corresponding storage medium through a storage controller.

3. Operation System (OS)

The operation system is a group of system software programs related with each other for managing and controlling computer operations, applying and running hardware and software, and providing public services for organizing user interaction. While the electronic device starts the OS, a virtual file system (for example, initramfs) is firstly started, and a driver of a system disk storage controller and a driver of a data disk storage controller are started while starting the virtual file system, and then a root file system is started. A function of the virtual file system is used for mounting root file system. An operation of mounting is a process for associating a file system with a storage medium. The root file system includes directories and important files, which are needed for starting the OS, and files, which are needed for mounting other file systems.

4. Driver Source File

A driver source file includes the drivers of the storage controller. When starting the operating system, the electronic device acquires the drivers of the storage controller from the driver source file. The driver source file can be a kernel object (KO) file.

5. Driver Configuration File

A driver configuration file includes information of install configuration for starting the driver of the storage controller, such as a type of the storage controller, information of a version of the storage controller.

6. Driver Image File

A driver image file includes the content of the driver configuration file. The electronic device may open the driver image file in a virtual file system, thus the driver of the storage controller starts according to the driver image file while starting the virtual file system.

7. Driver Mapping File

A driver mapping file includes information of dependency relationship between modules of the operation system. The electronic device may open the driver mapping file in the root file system, thus the driver of the storage controller starts according to the driver mapping file while starting the root file system.

8. Drive Letter

A drive letter is an identifier of the storage medium to the operation system. While starting an operation system of the electronic device, drivers of the storage controller is firstly started for scanning storage mediums. The storage controller allocates drive letters to the storage mediums according to a scanning order. The drivers of the storage controller are run multithreaded, which is difficult to determining a sequence of running the drivers. The drive letters are randomly allocated, thus the drive letters may be shifted.

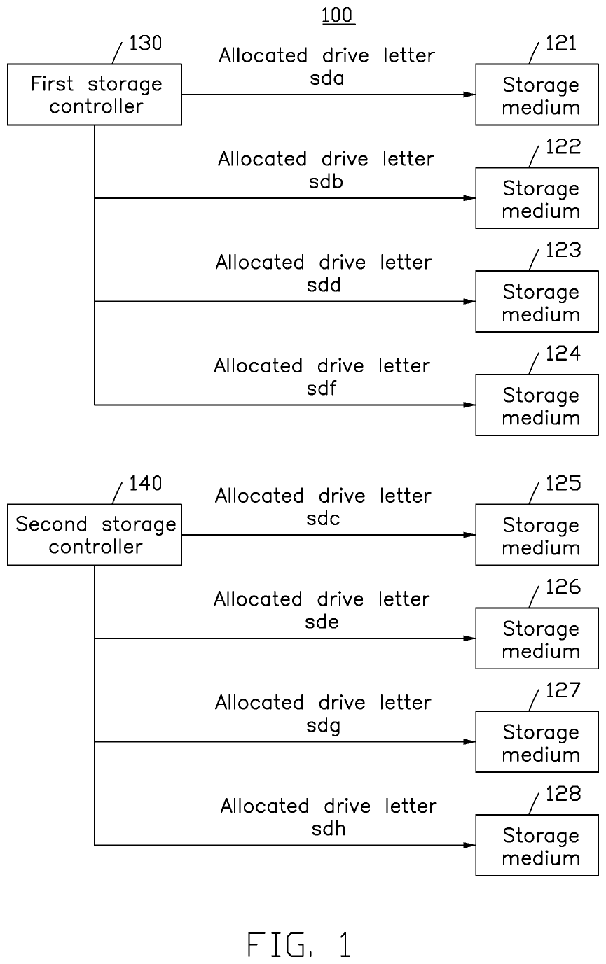

For example, as shown in FIG. 1, the electronic device 100 includes a first storage controller 130 and a second storage controller 140. The first storage controller 130 is electrically connected with storage mediums 121, 122, 123, 124. The second storage controller 140 is electrically connected with storage mediums 125, 126, 127, 128. While starting the operation system, the electronic device 100 firstly starts the drivers of the first storage controller 130 for scanning the storage mediums 121 and 122. The drive letters “sda” and “sdb” are respectively allocated to the storage mediums 121 and 122 in that order. Then, the electronic device 100 starts the drivers of the second storage controller 140 for scanning the storage medium 125. The drive letter “sdc” is allocated to the storage medium 125. Further, the electronic device 100 starts the drivers of the first storage medium 123. The drive letter “sdd” is allocated to the storage medium 123. After that, the electronic device 100 starts the drivers of the first storage medium 126. The drive letter “sde” is allocated to the storage medium 126. After that, the electronic device 100 starts the drivers of the first storage medium 124. The drive letter “sdf” is allocated to the storage medium 124. After that, the electronic device 100 starts the drivers of the storage mediums 127 and 128. The drive letters “sdg” and “sdh” are respectively allocated to the storage mediums 127 and 128 in that order. Thus, the drive letters of the storage mediums 121-124 managed by the first storage controller 130 are not continuous, and the drive letters of the storage mediums 125-128 managed by the second storage controller 140 are also not continuous. Therefore, the management of the storage mediums by the electronic device 100 has resulted in chaos. While operations of writing or erasing to the data disk, if the first drive letter is the drive letter of data disk, the operations of writing or erasing may be wrongly applied to the drive letter of the system disk, which cause a data storage exception, even the operation system will be damaged.

Based on the above, the present disclosure provides a method for managing the storage controllers, an electronic device, and a computer readable storage medium. The method comprises updating driver configuration files of a second storage controller for making the driver image files of a virtual file system to include information of install configuration of drivers of the second storage controller, adjusting a starting time of the drivers of the second storage controller to be a starting time of the virtual file system, starting the drivers of the second storage controller in priority when starting the virtual file system, allocating drive letters to the storage mediums connected with the second storage controller in priority, then starting drivers of a first storage controller when starting a root file system, allocating drive letters to the storage mediums connected with the first storage controller, thus the drive letters allocated to the storage mediums connected with the first storage controller and the second storage controller are continuous.

The electronic device is described as follows.

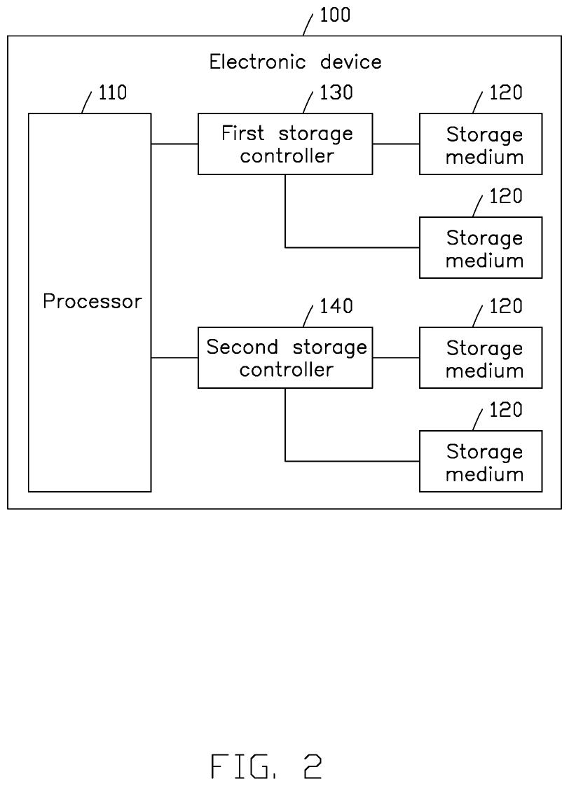

FIG. 2 shows a first embodiment of an electronic device 100 of the present disclosure.

Referring to FIG. 2, the electronic device 100 may include a processor 110, a plurality of storage mediums 120, a first storage controller 130, and a second storage controller 140. The first storage controller 130 and the second storage controller 140 are respectively connected with several storage mediums 120. The processor 110 may execute computer programs or codes stored in one of the storage mediums 120 to implement a method for managing storage controllers of the present disclosure.

The processor 110 may include one or more processing unit. For example. The processor 110 may include, but not being limited, an application processor (AP), a modem processor, a graphics processing unit (GPU), an image signal processor (ISP), a controller, a memory, a video codec, a digital signal processor (DSP), a baseband processor, and/or a neural-network processing unit (NPU). Different processing units may be separate components or integrated in one or more processors.

The processor 110 also may also be provided with a memory for storing instructions and data. In some embodiments, the memory in the processor 110 is a cache memory. The memory can store instructions or data created or used or recycled by the processor 110. If the processor 110 needs to use the instructions or data again, it can be called up directly from the memory.

In some embodiments, the processor 110 may include one or more interfaces. The interface may include an integrated circuit (I2C) interface, an integrated circuit sound (I2S) interface, a pulse code modulation (PCM) interface, a universal asynchronous receiver/transmitter (UART) interface, and a mobile industry processor interface (MIPI), general purpose input/output (GPIO) interface, SIM interface, and/or USB interface, and the like.

It can be understood that the interface connection relationship between the modules illustrated in this embodiment is merely illustrative and does not constitute a structural limitation on the electronic device 100. In some other embodiments, the electronic device 100 may alternatively use an interface connection manner different than the foregoing embodiment, or a combination of multiple interface connection manners.

The storage medium 120 may include an external storage interface and an internal storage medium. The external storage interface may be configured to connect an external storage medium, for example, a micro SD card, to expand a storage capacity of the electronic device 100. The external storage medium communicates with the processor 110 by using the external memory interface to implement a data storage function. The internal storage medium may be configured to store computer-executable program codes, where the computer-executable program codes include instructions. The internal storage medium may include a program storage area (system disk) and a data storage area (data disk). The program storage area may store an operation system, an application program required by at least one function (for example, a sound play function or an image play function), and the like. The data storage area may store data (for example, audio data and address book) created during the use of the electronic device 100. In addition, the internal memory may include a high-speed random access memory and may further include a non-volatile memory, for example, at least one magnetic disk storage device, a flash memory, or a universal flash storage (universal flash storage, UFS). The processor 110 runs the instruction stored in the internal memory and/or the instruction stored in the memory disposed in the processor 110, to perform various function applications of the electronic device 100 and data processing, for example, to implement the method of managing storage controllers of the present disclosure.

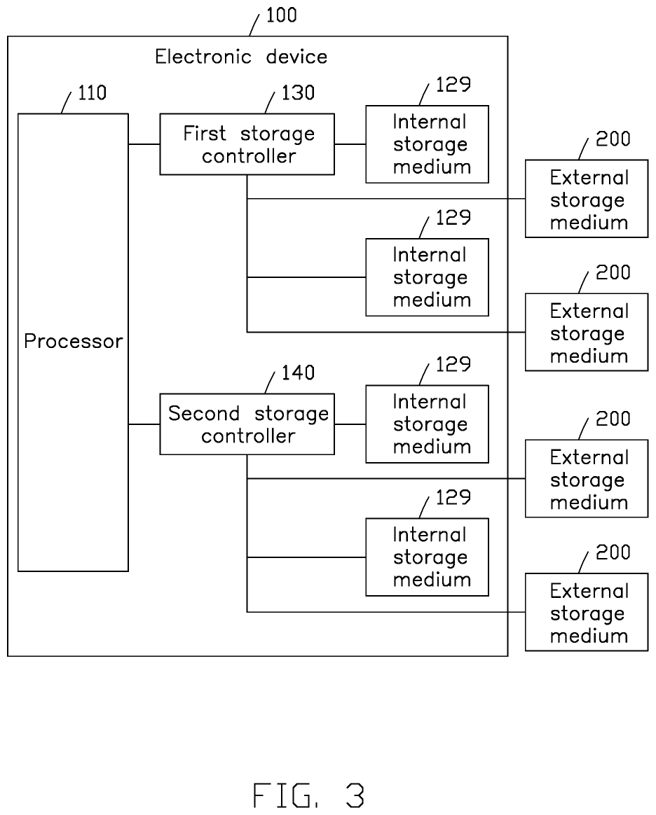

FIG. 3 shows a second embodiment of the electronic device 100.

Referring to FIG. 3, the electronic device 100 may include a processor 110, at least one internal storage medium 129, a first storage controller 130, and a second storage controller 140. When the electronic device 100 connects with at least one external storage medium 200, the processor 110 may run a computer program or code stored in one of the at least one internal storage medium 129 to implement the method for managing the storage controllers of the present disclosure.

In one embodiment, there are a plurality of internal storage mediums 129 and a plurality of external storage mediums 200. The first storage controller 130 is electrically connected with the at least one of the plurality of the internal storage mediums 129 and at least one of the plurality of the external storage mediums 200, the second storage controller 140 is electrically connected with the rest of the plurality of the internal storage mediums 129 and the plurality of the external storage mediums 200, which are not connected with the first storage medium controller 130.

In some embodiments, the first storage controller 130 is electrically connected with the plurality of internal storage mediums 129, and the second storage controller 140 is electrically connected with the plurality of external storage mediums 200.

It is understood that the structure shown in this embodiment of the present technology does not constitute a specific limitation on the electronic device 100. In some other embodiments of this application, the electronic device 100 may include more or fewer components than those shown in the figure, or combine some components, or split some components, or have different component arrangements. The components shown in the figure may be implemented by hardware, software, or a combination of software and hardware.

The electronic device 100 may include a smart phone, a tablet, a personal computer (PC), an e-book reader, a work station, a server, a personal digital assistant (PDA), a portable multimedia player (PMP), and the like, but not being limited.

A method for managing the storage controllers of the present disclosure will be described as flow.

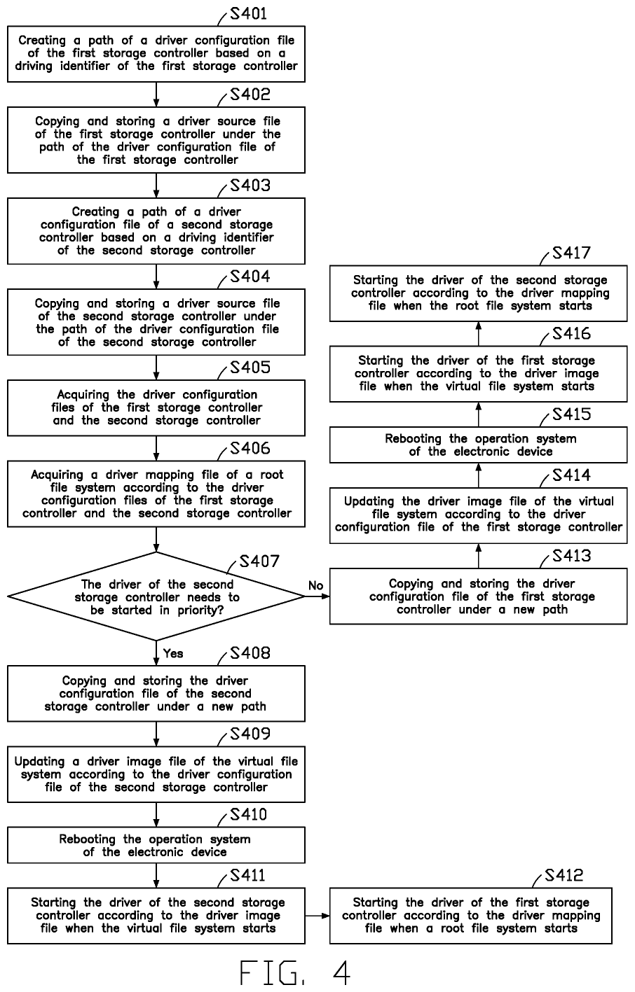

FIG. 4 shows a flowchart of the method for managing the storage controllers.

Referring to FIG. 4, the method for managing the storage controllers is used in the electronic device as shown in FIG. 2 or FIG. 3. The method may comprise at least the following steps, which also may be re-ordered.

In block S401, a path of a driver configuration file of the first storage controller 130 is created based on a driver identifier of the first storage controller 130.

It is understood that the driver identifier is used to distinguish different drivers. The driver identifier may include a driver name or a driver serial, for example, the driver identifier may be “mpt3sas”, “megaraid_sas”, or “aacraid”.

In one embodiment, the electronic device 100 may use a “mkdir” command to create the path of the driver configuration file of the first storage controller 130.

For example, the driver identifier of the first storage controller 130 is “DriverModule_A”, the command for creating the path of the driver configuration file of the first storage controller 130 by the electronic device 100 is shown as follow.
mkdir -p /lib/modules/‘uname -r’/extra/$DriverModule_A/

In block S402, a driver source file of the first storage controller 130 is copied and stored under the path of the driver configuration files of the first storage controller 130.

In one embodiment, the electronic device 100 may use a “cp” command to copy the driver source file of the first storage controller 130.

For example, the name of the driver source file is “$DriverModule_A.ko”, the command for copying the driver source file of the first storage controller 130 by the electronic device 100 is shown as follow.
cp -f $DriverModule_A.ko /lib/modules/‘uname -r’/extra/$DriverModule_A/

In block S403, a path of a driver configuration file of the second storage controller 140 is created based on a driver identifier of the second storage controller 140.

For example, the driver identifier of the second storage controller 140 is “DriverModule_B”, the command for creating the path of the driver configuration file of the second storage controller 140 by the electronic device 100 is shown as follow.
mkdir -p /lib/modules/‘uname -r’/extra/$DriverModule_B/

In block S404, a driver source file of the second storage controller 140 is copied and stored under the path of the driver configuration file of the second storage controller 140.

For example, the name of the driver source file is “$DriverModule_B.ko”, the command for copying the driver source file of the second storage controller 140 by the electronic device 100 is shown as follow.
cp -f $DriverModule_B.ko /lib/modules/‘uname -r’/extra/$DriverModule_B/

In block S405, the driver configuration files of the first storage controller 130 and the second storage controller 140 are acquired.

In one embodiment, the electronic device 100 uses the driver identifier of the first storage controller 130 as a file name of the driver configuration file of the first storage controller 130 and uses the driver identifier of the second storage controller 140 as a file name of the driver configuration file of the second storage controller 140.

In some embodiments, the electronic device 100 stores the driver configuration files of the first storage controller 130 and the second storage controller 140 under a path of a driver mapping file.

In other embodiments, the electronic device 100 may user a “override” command for overriding the driver configuration files of the first storage controller 130 and the second storage controller 140.

For example, the command for overriding the driver configuration file of the first storage controller 130 by the electronic device 100 is shown as follow.
echo override $DriverModule_A ‘uname -r|awk -F “-”‘{print $1}’’-* weak-updates/$DriverModule_A>/etc/depmod.d/$DriverModule_A.conf

The command for overriding the driver configuration file of the second storage controller 140 by the electronic device 100 is shown as follow.
echo override $DriverModule_B ‘uname -r|awk -F “-”‘{print $1}’’-* weak-updates/$DriverModule_B>/etc/depmod.d/$DriverModule_B.conf

The “$DriverModule_A.conf” is a name of the driver configuration file of the first storage controller 130, and the “$DriverModule_B.conf” is a name of the driver configuration file of the second storage controller 140.

In block S406, a driver mapping file of a root file system is acquired according to the driver configuration files of the first storage controller 130 and the second storage controller 140.

In one embodiment, the electronic device 100 may use a “depmod” command to create the driver mapping file of the root file system.

It is understood that after creating the driver mapping file, the electronic device 100 may start the drivers of the first storage controller 130 and the second storage controller 140 according to the diver mapping file when starting the root file system.

In block S407, determining whether the driver of the second storage controller 140 needs to be started in priority.

In one embodiment, the electronic device 100 may store a starting priority list. The starting priority list includes a priority sequence of the drivers of different types of the storage controllers. The electronic device 100 acquires a priority sequence of the drivers of the first storage controller 130 and the second storage controller 140 by searching the starting priority list. The electronic device 10 starts the driver of the first storage controller 130 according to the acquired priority sequence or starts the driver of the second storage controller 140 according to the acquired priority sequence.

In some embodiments, the electronic device 100 confirms the driver of the first storage controller 130 or the driver of the second storage controller 140 in response to a priority starting instruction.

It is understood that a display of the electronic device 100 may display controls for starting the drivers of the first storage controller 130 and the second storage controller 140 in priority. When the control for starting the driver of the first storage controller 130 is triggered, the priority starting instruction for starting the driver of the first storage controller 130 is generated, the electronic device 100 confirms the driver of the first storage controller 130 to be started in priority in response to the generated priority starting instruction. When the control for starting the driver of the second storage controller 140 is triggered, the priority starting instruction for starting the driver of the second storage controller 140 is generated, the electronic device 100 confirms the driver of the second storage controller 140 to be started in priority in response to the generated priority starting instruction. The controls for starting the driver of the first storage controller 130 and the second storage controller 140 are triggered by user's operations, such as a click operation or a touch operation.

If it is determined that the driver of the second storage controller 140 needs to be started in priority, the procedure goes to the block S408, if it is determined that the driver of the second storage controller 140 does not need to be started in priority, the procedure goes to the block S413.

In block S408, the driver configuration file of the second storage controller 140 is copied and stored under a new path.

In one embodiment, when it is determined that the driver of the second storage controller 140 needs to be started in priority, the electronic device 100 creates the driver configuration file of the second storage controller 140 under the new path. For example, the electronic device 100 creates the driver configuration file under a path of a driver image file.

It is understood that the electronic device 100 may use a “add_drivers” command for creating the driver configuration file of the second storage controller 140.

For example, the command creating the driver configuration file of the second storage controller 140 by the electronic device 100 is shown as follow.
echo add_drivers+=\“$DriverModule_B\”>/etc/dracut.conf.d/$DriverModule_B.conf

The name of the recreated driver configuration file of the second storage controller 140 is “$DriverModule_B.conf”.

It is understood that when it is determined that the driver of the second storage controller 140 needs to be started in priority, the electronic device 100 adjusts a starting time of the driver of the second storage controller 140 to the stage of starting a virtual file system by copying and storing the driver configuration file of the second storage controller 140 in the new path, thus the storage mediums connected with the second storage controller 140 are allocated with the drive letters in priority, the operation for allocating the drive letters to the storage mediums connected with the first storage controller 130 is not being disturbed.

In block S409, a driver image file of the virtual file system is updated according to the driver configuration file of the second storage controller 140.

In one embodiment, the electronic device 100 may use a “dracut” command to create the driver image file of the virtual file system and replaces the original driver image file before being updated. The driver image file of the virtual file system only includes the driver configuration file of the second storage controller 140.

In some embodiments, the electronic device 100 changes content of the driver image file of the virtual file system according to content of the driver configuration file of the second storage controller 140.

In block S410, the operation system of the electronic device 100 is rebooted.

In one embodiment, the electronic device 100 may use a “reboot” command to reboot the operation system.

In some embodiments, the electronic device 100 may reboot the operation system in response to a reboot instruction.

It is understood that the display of the electronic device 100 displays a reboot control. When the reboot control is triggered, the reboot instruction is generated, the electronic device 100 response to the reboot instruction for rebooting the operation system. The reboot control may be triggered by the user's operation, such as a click operation or a touch operation. The reboot control also be set with a waiting time. When the user's operation exceeds the waiting time, the operation triggers the reboot control for generating the reboot instruction.

In block S411, the driver of the second storage controller 140 is started according to the driver image filled when the virtual file system starts.

It is understood that the operation of rebooting the operation system of the electronic device 100 includes a stage of starting the virtual file system and a stage of starting the root file system. After the virtual file system being started, the root file system starts.

In one embodiment, when it is determined that the driver of the second storage controller 140 needs to be started in priority, the content of the driver image file includes the driver of the second storage controller 140, the electronic device 100 starts the driver of the second storage controller 140 according to the driver image file when starting the virtual file system, the storage mediums connected with the second storage controller 140 are allocated with the drive letters in priority, the operation for allocating the drive letters to the storage mediums connected with the first storage controller 130 is not being disturbed.

In block S412, the driver of the first storage controller 130 starts according to the driver mapping file when the root file system starts.

In one embodiment, after the virtual filesystem being started, the electronic device 100 starts the driver of the first storage controller 130 at the stage of starting the root file system, thus the drive letters are allocated to the storage mediums connected with the first storage controller 130. The drive letters of the storage mediums connected with the second storage controller 140 have been allocated at the stage of starting the virtual file system, the operation for allocating the drive letters to the storage mediums connected with the first storage controller 130 is not being disturbed.

It is understood that after the root file system is completely loaded, the operation system may load other file system. The loading operation indicates a process of reading information in the memory of the electronic device 100 while the root file system starts. When all the file systems are loaded, the operation of rebooting the operation system is completed. After the operation system being completely rebooted, the electronic device 100 may access the storage mediums through the first storage controller 130 or the second storage controller 140.

In block S413, the driver configuration file of the first storage controller 130 is updated.

For example, the command for creating the driver configuration file of the first storage controller 130 by the electronic device 100 is shown as follows.
echo add_drivers+=\“$DriverModule_A\”>/etc/dracut.conf.d/$DriverModule_A.conf

The name of the driver configuration file of the first storage controller 130 is “DriverModule_A.conf”.

In block S414, the driver image file of the virtual file system is updated according to the driver configuration file of the first storage controller 130.

In block S415, the operation system of the electronic device 100 is rebooted.

In block S416, the driver of the first storage controller 130 is started according to the driver image filled when the virtual file system starts.

In block S417, the driver of the second storage controller 140 starts according to the driver mapping file when the root file system starts.

It is understood that the blocks S413-S417 are similar to the blocks S408-S412, details are not described herein again.

In one embodiment when it is determined that the driver of the first storage controller 130 needs to be started in priority, the electronic device 100 adjusts a starting time of the driver of the first storage controller 130 to the stage of starting the virtual file system by copying and storing the driver configuration file of the first storage controller 130 in the new path, thus the storage mediums connected with the first storage controller 130 are allocated with the drive letters in priority, the operation for allocating the drive letters to the storage mediums connected with the second storage controller 140 is not being disturbed.

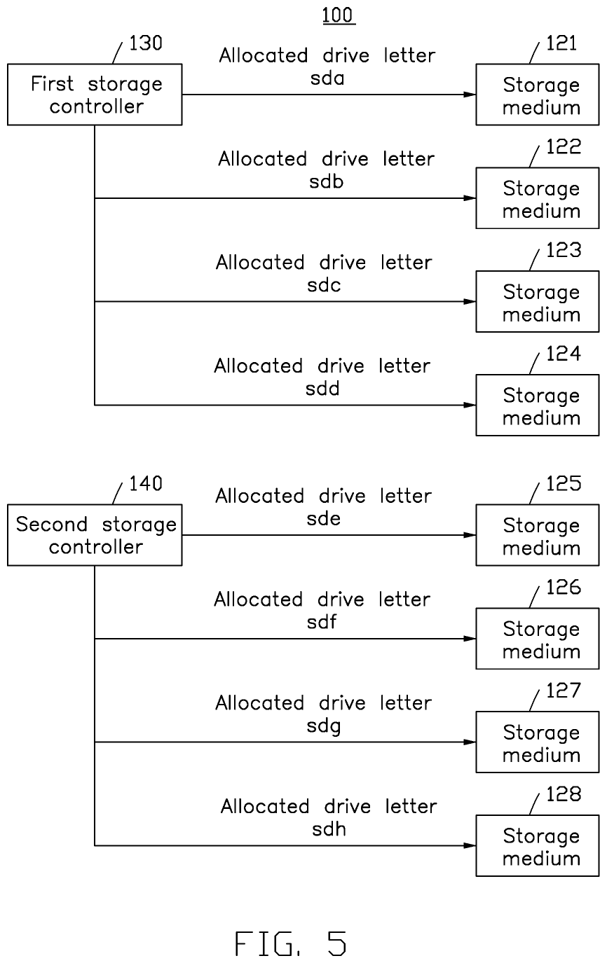

For example, as shown in FIG. 5, the electronic device 100 includes the first storage controller 130 and the second storage controller 140. The first storage controller 130 connects with the storage mediums 121-124, and the second storage controller 140 connects with the storage mediums 125-128. The electronic device 100 uses the method for managing the storage controllers. When the driver of the first storage controller 130 is determined to be started in priority, while starting the operation system, the electronic device 100 firstly starts the driver of the first storage controller 130 when the virtual file system starts, the first storage controller 130 scans the storage mediums 121-124 and allocates the drive letters to the storage mediums 121-124, which are “sda”, “sdb”, “sdc”, and “sdd”. Then, the electronic device 100 starts the driver of the second storage controller 140 when the root file system starts, the second storage controller 140 scans the storage mediums 125-128 and allocates the drive letters to the storage mediums 125-128, which are “sde”, “sdf”, “sdg”, and “sdh”. The drive letters allocated to the storage mediums 121-124 managed by the first storage controller 130 are continuous, and the drive letters allocated to the storage mediums 125-128 managed by the second storage controller 140 are also continuous.

The present discloses also provides a computer readable storage medium. The computer readable storage medium stores computer programs or codes, when being executed to perform the foregoing method for managing the storage controllers.

The computer storage medium includes volatile and nonvolatile, removable and non-removable media implemented in any method or technology for storing information such as computer readable instructions, data structures, program modules or other data. The computer storage medium includes, but is not being limited, Random Access Memory (RAM), Read-Only Memory (ROM), Electrically Erasable Programmable Read-Only Memory (EEPROM), flash memory or other memory technologies, Compact Disc Read-Only Memory (CD-ROM), digital versatile disks (DVD) or other optical disk storages, magnetic cassettes, magnetic tapes, magnetic disk storages or other magnetic storage devices or any other media that may be used to store desired information and may be accessed by a computer.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for managing storage controllers, the method is applicable in an electronic device;
the electronic device is provided with storage mediums with computer programs and a processor;
the processor executes the computer programs to implement following processes:
acquiring driver configuration files of a first storage controller and a second storage controller;
acquiring a driver mapping file of a root file system according to the driver configuration files of the first storage controller and the second storage controller;
copying and storing the driver configuration file of the second storage controller under a new path;
updating a driver image file of a virtual file system according to the driver configuration file of the second storage controller;
rebooting an operation system of the electronic device;
starting a driver of the second storage controller according to the driver image file when the virtual file system starts; and
starting a driver of the first storage controller according to the driver mapping file when a root file system starts.

2. The method of claim 1, before copying and storing the driver configuration file of the second storage controller under the new path, the method further comprises:
determining whether the driver of the second storage controller needs to be started in priority; and
copying and storing the driver configuration file of the second storage controller under the new path, if the driver of the second storage controller is determined that it needs to be started in priority.

3. The method of claim 2, the method further comprises:
copying and storing the driver configuration file of the first storage controller under the new path, if the driver of the second storage controller is determined that it does not need to be started in priority;
updating the driver image file of the virtual file system according to the driver configuration file of the first storage controller;
rebooting the operation system of the electronic device;
starting the driver of the first storage controller according to the driver image file when the virtual file system starts; and
starting the driver of the second storage controller according to the driver mapping file when a root file system starts.

4. The method of claim 1, before acquiring the driver configuration files of the first storage controller and the second storage controller, the method further comprises:
creating a path of the driver configuration file of the first storage controller based on a driving identifier of the first storage controller;
copying and storing a driver source file of the first storage controller under the path of the driver configuration file of the first storage controller;
creating a path of the driver configuration file of a second storage controller based on a driving identifier of the second storage controller; and
copying and storing a driver source file of the second storage controller under the path of the driver configuration file of the second storage controller.

5. The method of claim 1, acquiring the driver configuration files of the first storage controller and the second storage controller comprises:
naming the driver configuration file of the first storage controller by a driver identifier of the first storage controller; and
naming the driver configuration file of the second storage controller by a driver identifier of the second storage controller.

6. The method of claim 1, before acquiring the driver mapping file of the root file system according to the driver configuration files of the first storage controller and the second storage controller, the method further comprises:
storing the driver configuration files of the first storage controller and the second storage controller under a path of the driver mapping file.

7. The method of claim 1, before updating the driver image file of the virtual file system according to the driver configuration file of the second storage controller, the method further comprises:
creating the driver configuration file of the second storage controller under a path of the driver image file.

8. An electronic device connected with at least one external storage medium, the electronic device comprises:
at least one internal storage medium;
a first storage controller;
a second storage controller; and
a processor,
wherein the at least one internal storage medium stores computer programs, and
the processor executes the computer programs to implement following processes when the electronic device connects with an external storage medium:
acquiring driver configuration files of the first storage controller and the second storage controller;
acquiring a driver mapping file of a root file system according to the driver configuration files of the first storage controller and the second storage controller;
copying and storing the driver configuration file of the second storage controller under a new path;
updating a driver image file of a virtual file system according to the driver configuration file of the second storage controller;
rebooting an operation system of the electronic device;
starting a driver of the second storage controller according to the driver image file when the virtual file system starts; and
starting a driver of the first storage controller according to the driver mapping file when a root file system starts.

9. The electronic device of claim 8, before copying and storing the driver configuration file of the second storage controller under the new path, the processor further:
determining whether the driver of the second storage controller needs to be started in priority;
copying and storing the driver configuration file of the second storage controller under the new path, if the driver of the second storage controller is determined that it needs to be started in priority;
copying and storing the driver configuration file of the first storage controller under the new path, if the driver of the second storage controller is determined that it does not need to be started in priority;
updating the driver image file of the virtual file system according to the driver configuration file of the first storage controller;
rebooting the operation system of the electronic device;
starting the driver of the first storage controller according to the driver image file when the virtual file system starts; and
starting the driver of the second storage controller according to the driver mapping file when a root file system starts.

10. The electronic device of claim 8, before acquiring the driver configuration files of the first storage controller and the second storage controller, the processor further comprises:
creating a path of the driver configuration file of the first storage controller based on a driving identifier of the first storage controller;
copying and storing a driver source file of the first storage controller under the path of the driver configuration file of the first storage controller;
creating a path of the driver configuration file of a second storage controller based on a driving identifier of the second storage controller; and
copying and storing a driver source file of the second storage controller under the path of the driver configuration file of the second storage controller.

11. The electronic device of claim 8, acquiring the driver configuration files of the first storage controller and the second storage controller comprises:
naming the driver configuration file of the first storage controller by a driver identifier of the first storage controller; and
naming the driver configuration file of the second storage controller by a driver identifier of the second storage controller.

12. The electronic device of claim 8, before acquiring the driver mapping file of the root file system according to the driver configuration files of the first storage controller and the second storage controller, the processor further:
storing the driver configuration files of the first storage controller and the second storage controller under a path of the driver mapping file.

13. The electronic device of claim 8, wherein before updating the driver image file of the virtual file system according to the driver configuration file of the second storage controller, the processor further:
creating the driver configuration file of the second storage controller under a path of the driver image file.

14. An electronic device comprises:
a plurality of storage mediums;
a first storage controller;
a second storage controller; and
a processor,
wherein the plurality of the storage medium stores computer programs, and
the processor executes the computer programs to implement following processes:
acquiring driver configuration files of the first storage controller and the second storage controller;
acquiring a driver mapping file of a root file system according to the driver configuration files of the first storage controller and the second storage controller;
copying and storing the driver configuration file of the second storage controller under a new path;
updating a driver image file of a virtual file system according to the driver configuration file of the second storage controller;
rebooting an operation system of the electronic device;
starting a driver of the second storage controller according to the driver image file when the virtual file system starts; and
starting a driver of the first storage controller according to the driver mapping file when a root file system starts.

15. A computer readable storage medium, the computer readable storage medium stores computer programs, and the computer programs are executed by at least one processor to implement following steps:
acquiring driver configuration files of a first storage controller and a second storage controller;
acquiring a driver mapping file of a root file system according to the driver configuration files of the first storage controller and the second storage controller;
copying and storing the driver configuration file of the second storage controller under a new path;
updating a driver image file of a virtual file system according to the driver configuration file of the second storage controller;
rebooting the operation system of the electronic device;
starting a driver of the second storage controller according to the driver image file when the virtual file system starts; and
starting a driver of the first storage controller according to the driver mapping file when a root file system starts.

16. The computer readable storage medium of claim 15, before copying and storing the driver configuration file of the second storage controller under the new path, the method further comprises:
determining whether the driver of the second storage controller needs to be started in priority;
copying and storing the driver configuration file of the second storage controller under the new path, if the driver of the second storage controller is determined that it needs to be started in priority;
copying and storing the driver configuration file of the first storage controller under the new path, if the driver of the second storage controller is determined that it does not need to be started in priority;
updating the driver image file of the virtual file system according to the driver configuration file of the first storage controller;
rebooting an operation system of the electronic device;
starting the driver of the first storage controller according to the driver image file when the virtual file system starts; and
starting the driver of the second storage controller according to the driver mapping file when a root file system starts.

17. The computer readable storage medium of claim 15, before acquiring the driver configuration files of the first storage controller and the second storage controller, the method further comprises:
creating a path of the driver configuration file of the first storage controller based on a driving identifier of the first storage controller;
copying and storing a driver source file of the first storage controller under the path of the driver configuration file of the first storage controller;
creating a path of the driver configuration file of a second storage controller based on a driving identifier of the second storage controller; and
copying and storing a driver source file of the second storage controller under the path of the driver configuration file of the second storage controller.

18. The computer readable storage medium of claim 15, acquiring the driver configuration files of the first storage controller and the second storage controller comprises:
naming the driver configuration file of the first storage controller by a driver identifier of the first storage controller; and
naming the driver configuration file of the second storage controller by a driver identifier of the second storage controller.

19. The computer readable storage medium of claim 15, before acquiring the driver mapping file of the root file system according to the driver configuration files of the first storage controller and the second storage controller, the method further comprises:
storing the driver configuration files of the first storage controller and the second storage controller under a path of the driver mapping file.

20. The computer readable storage medium of claim 15, before updating the driver image file of the virtual file system according to the driver configuration file of the second storage controller, the method further comprises:
creating the driver configuration file of the second storage controller under a path of the driver image file.
